(19) United States
(12) Patent Application Publication
(10) Pub. No.: US 2005/0246756 A1
(43) Pub. Date: Nov. 3, 2005

(54) System and method for providing multiple services in HFC CATV networks

(75) Inventors: John G. Leddy, Philadelphia, PA (US); Vivek Saxena, Philadelphia, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/833,430

(22) Filed: Apr. 28, 2004

(51) Int. Cl. H04N 7/173

(52) U.S. Cl. 725/129; 725/118; 725/126

(57) ABSTRACT

Various channels containing digital data for CATV services are distributed over the HFC CATV network from the headend. Digital data is modulated on RF sub-carriers within an allocated downstream RF spectrum. The allocated downstream RF spectrum is split such that different parts of the RF spectrum are transmitted by WDM lasers in a transmitter system including an array of such lasers. The transmitter system utilizes WDM to combine different wavelengths from the laser array on the transmitter side and then launches them onto a single fiber. The transmitted optical signals impinge on a single photo device which reproduces the combined RF spectrum at its output.

### BACKGROUND OF THE INVENTION

1. Field of the Invention

The invention relates to providing multiple services in hybrid fiber coax (HFC) cable television (CATV) networks.

2. Background Art

The HFC CATV network includes a headend that distributes signals over fiber to field nodes in the network. From the field nodes, distribution through the neighborhoods to the subscribers is over coax cable.

For traditional broadcast TV service, most HFC CATV systems collect satellite and trunk cable feeds, local off-the-air television channels, and other video/audio channels, and distribute them from the headend to the field node on a fiber using an amplitude modulated vestigial sideband (AM-VSB) scheme which places channels onto different sub-carriers within the frequency spectrum allocated for CATV downstream transmission (55/65 MHz to 750/860/1000 MHz) so that each channel occupies 6 MHz of the spectrum.

On the other hand, most new services being offered on cable such as video-on-demand (VOD), digital TV, high-speed data (HSD), and IP telephony, are distributed by using multilevel quadrature amplitude modulation (M-QAM) of sub-carriers within the 55-860 MHz range. In the M-QAM scheme, both amplitude and phase of the sub-carrier are varied to represent each digital symbol. For example, in a 256 QAM, 256 combinations of amplitude and phase are used.

The M-QAM channels may either be combined with the AM-VSB channels and the combined RF signal may drive the same laser (this is referred to as hybrid multichannel AM-VSB/M-QAM transport architecture), or the two types of modulated channels could drive separate lasers independently and then be transmitted on different fibers.

There is still a desire for an improved method and system for providing multiple services in HFC CATV networks.

### SUMMARY OF THE INVENTION

It is an object of the invention to provide an improved system and method for providing multiple services in HFC CATV networks.

In carrying out the invention, systems and methods are provided. In one aspect of the invention, various channels containing digital data for CATV services are distributed over the HFC CATV network from the headend. The digital data is modulated onto radio frequency (RF) sub-carriers within an allocated downstream RF spectrum. The allocated downstream RF spectrum is split such that different parts (different sub-carriers) of the RF spectrum are transmitted by separate wavelength division multiplexed (WDM) lasers in a transmitter system including an array of such lasers.

The transmitter system utilizes wavelength division multiplexing (WDM) to combine different wavelengths from the laser array on the transmitter side and then launch them onto a single fiber. On the receiver side, the transmitted optical signal impinge on a single photo device which reproduces the combined RF spectrum at its output.

At a more detailed level, the invention comprehends additional features. The invention comprehends utilizing multilevel quadrature amplitude modulation (M-QAM) of radio frequency sub-carriers for downstream transmission of the digital data. Further, the digital data may be for any number of CATV services including, for example, voice, video, and Internet access.

The invention further comprehends the allocated downstream RF spectrum being split such that the different parts of the RF spectrum are transmitted by separate dense wavelength division multiplexed (DWDM) lasers in a transmitter system including an array of such lasers. In further comprehended detail, this aspect of the invention utilizes DWDM to combine the different International Telecommunications Union (ITU) grid wavelengths from the laser array on the transmitter side and launch them on a single fiber.

Still further, at a more detailed level, the invention comprehends additional features. More specifically, the photo device on the receiver side may be a photodiode. In this way, on the receiver side, unfiltered optical signals impinge on a single photodiode which reproduces the combined RF spectrum at its output.

### BRIEF DESCRIPTION OF THE DRAWINGS

FIG. 1 is a hybrid fiber coax (HFC) cable television (CATV) network in which an embodiment of the invention is illustrated; and

FIG. 2 is a block diagram illustrating a method in an embodiment of the invention.

### DETAILED DESCRIPTION OF THE PREFERRED EMBODIMENTS

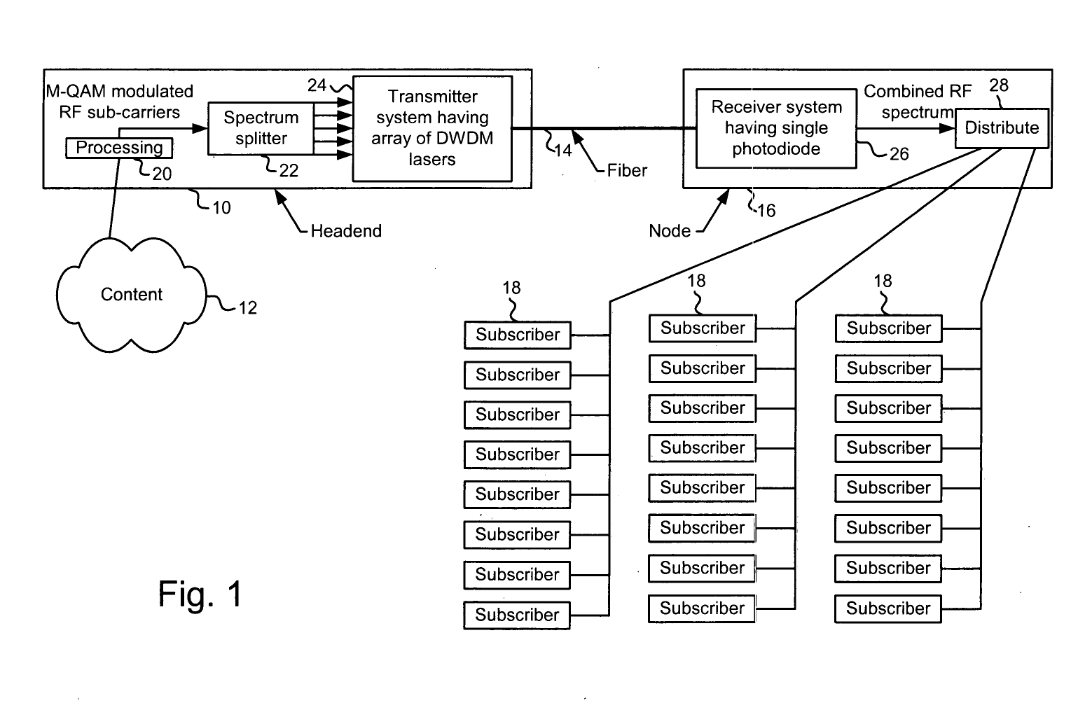

With reference to FIG. 1, the HFC CATV network includes a headend 10 that receives content from a number of content sources 12. Headend 10 distributes signals over fiber 14 through hubs (not shown) to field nodes 16 in the network, which is illustrated in a simplified fashion. From field nodes 16, distribution through the neighborhoods to subscribers 18 takes place over coax cable.

The HFC CATV network provides multiple services. Content from content sources 12 is processed by processing block 20 in a known fashion to produce various channels containing digital data for CATV services. The digital data is modulated onto radio frequency (RF) sub-carriers within an allocated downstream RF spectrum. As shown, multilevel quadrature amplitude modulation (M-QAM) of the RF sub-carriers is utilized in the downstream transmission of the digital data. The digital data itself may be for any number of CATV services including, for example, voice, video, and Internet access.

The allocated downstream RF spectrum is split by splitter 22 such that different parts (different sub-carriers) of the RF spectrum are transmitted by separate wavelength division multiplexed (WDM) lasers in a transmitter system 24 including an array of such lasers.

Transmitter system 24 utilizes wavelength division multiplexing (WDM) to combine different wavelengths from the laser array on the transmitter side and then launch them onto a single fiber 14. As shown the allocated downstream RF spectrum is split such that the different parts of the RF spectrum are transmitted by separate dense wavelength division multiplex (DWDM) lasers. DWDM is used to combine the different International Telecommunications Union (ITU) grid wavelengths from the laser array on the transmitter side and launch them on the single fiber 14.

On the receiver side, a receiver system 26 having a single photodiode receives the signal from fiber 14. Receiver system 26 reproduces the combined RF spectrum at its output. Distribution block 28 distributes the combined RF spectrum in a known fashion to subscribers 18.

It is appreciated that the illustrated embodiment employs a number of detail features that are preferred but other implementations are possible. In the preferred embodiment, digital data is modulated onto the radio frequency sub-carriers within the allocated downstream radio frequency spectrum utilizing multilevel quadrature amplitude modulation (M-QAM). Further, the transmitter system utilizes dense wavelength division multiplexing (DWDM).

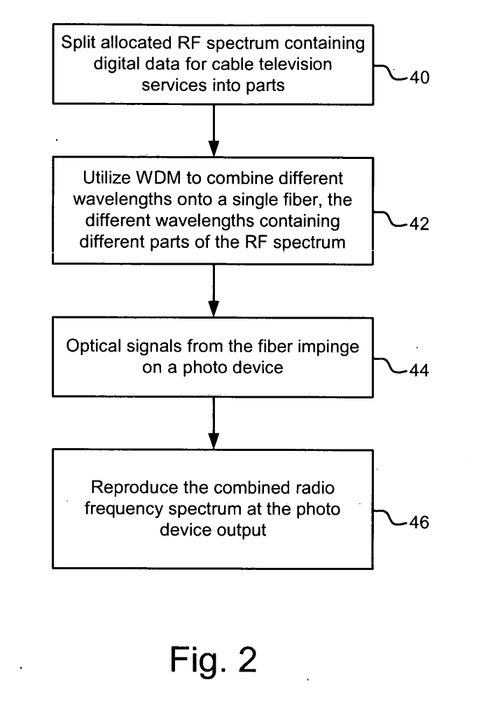

With reference to FIG. 2, a block diagram illustrates a method in an embodiment of the invention. At block 40, the allocated downstream RF spectrum containing digital data for cable television services is split into parts. Different parts of the spectrum are transmitted by different lasers of the array of lasers in the transmitter system. More specifically as indicated at block 42, wavelength division multiplexing (WDM) is utilized to combine different wavelengths onto a single fiber. The different wavelengths contain different parts of the RF spectrum. At block 44, the impinging of optical signals from the fiber on the photodiode is indicated. At block 46, the combined radio frequency spectrum is reproduced at the photodiode output.

Due to the large amounts of content that can be transmitted using M-QAM (for example, 256 QAM allows transmission of 12 movies with a 6 MHz channel at 3 Mb/s per second using digital video compression (it is desirable to split the 55-860 MHz RF spectrum such that distinct parts of the spectrum are dedicated to different services and transmitted by different lasers). More specifically, the downstream RF spectrum is split such that different parts of the RF spectrum are transmitted by different lasers within the array. The different parts of the RF spectrum correspond to different CATV services including, for example, voice, video, and Internet access.

The preferred arrangement utilizes dense wavelength division multiplexing (DWDM) to combine the different ITU grid wavelengths from the laser array on the transmitter side and launch them on a single fiber from the headend. On the receive side, the unfiltered optical signal impinges on a single photodiode which reproduces the combined RF spectrum at its output.

Since the failure rates of an optical receiver are much lower than those of the lasers, QAM modulators, and any RF up-converters, embodiments of the invention reduce the likelihood of a complete outage of services since at any given time only parts of the RF spectrum could be lost due to individual failures of components at the transmit side. Furthermore, the only upgrade required to the network for a basic implementation of the system is at the headend and no changes are necessary in the optical field nodes, which are typically configured with a single receiver.

In the preferred embodiments of the invention, the implementation is specifically tailored to better address interferometric noise and thermal noise.

Interferometric noise arrising from the optical beat frequencies (OBI) results from two or more lasers transmitting simultaneously onto the same optical channel. Due to the square law nature of the photo-detection process, the generated photo current would contain beat notes at frequencies corresponding to the differences in optical wavelengths. OBI worsens as the number of lasers increase or as the wavelengths are brought closer. To address this concern, in preferred embodiments, the ITU grid wavelengths should be selected such that they are farthest apart from each other while at the same time still fulfilling the requirements on the number of channels and optical transmission band(s). Another concern is the increase in the amount of thermal noise (electron agitation in a conductor) in the system since each laser is an independent source and thus the total noise power is the sum of the original noise powers (often expressed as relative intensity noise in a 1 Hz bandwidth) for the lasers. This increase in the thermal noise places a penalty on the carrier to noise (CNR) ratio. To address this concern in preferred embodiments, since the CNR required for M-QAM signals to achieve an acceptable bit error rate (BER) threshold is much lower (for example, 28 dB for BER of 10⁻⁸ for 64 QAM) than the CNR require for AM-VSB signals (43 dB CNR requirement as the subscriber), an architecture that uses all M-QAM channels could make this penalty insignificant.

There will be a 3 dB QAM SNR (Signal to Noise Ratio) degradation at the channels bordering the spectrum edges. Due to this degradation, these channels should be dedicated to services with a lower SNR requirement (such as data services) instead of SNR-sensitive video service. The flexibility in the architecture allows such RF frequency allocations. Alternately if the entire spectrum needs to be used for QAM-based video, a 3 dB system penalty would be incurred. As an alternative to incurring the penalty, preliminary amplification of channels bordering the spectrum edges may be used.

It is appreciated that in preferred embodiments, an all digital data transport using M-QAM is utilized instead of a hybrid architecture. This approach addresses AM-VSB limitations including laser clipping and frequency-chirp. However, in certain implementations AM-VSB channels could be added on a separate wavelength provided there is no RF spectrum overlap. It is further appreciated that preferred embodiments of the invention provide a solution for minimizing complete outage of multiple services (such as voice, video and high-speed Internet) that require transport of digital data from the headend to the fiber node, while saving the cost of labor and parts required for upgrading literally thousands of nodes that are installed in the HFC networks of every multi-service operator (MSO) today.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method for providing multiple services in a hybrid fiber coax (HFC) cable television (CATV) network, the cable television network including a headend that distributes signals over fiber to field nodes in the cable television network, the signals being distributed through the neighborhoods to subscribers from the field nodes, the distributed signals from the headend including a plurality of channels containing digital data for cable television services, the digital data being modulated onto radio frequency sub-carriers within an allocated downstream radio frequency spectrum, the method comprising:
providing a transmitter system including an array of lasers, the transmitter system utilizing wavelength division multiplexing (WDM) to combine different wavelengths from the laser array and launch them onto a single fiber, wherein the cable television network includes a receiver system including a photo device having an output, the optical signals from the single fiber impinging on the photo device; and
splitting the allocated downstream radio frequency spectrum into parts such that different parts of the spectrum are transmitted by different lasers of the array of lasers in the transmitter system, the photo device in the receiver system reproducing the combined radio frequency spectrum at the photo device output.

2. The method of claim 1 wherein the digital data is modulated onto the radio frequency sub-carriers within the allocated downstream radio frequency spectrum utilizing multilevel quadrature amplitude modulation (M-QAM).

3. The method of claim 1 wherein the digital data include digital data for voice service.

4. The method of claim 1 wherein the digital data include digital data for video service.

5. The method of claim 1 wherein the digital data include digital data for Internet access service.

6. The method of claim 1 wherein the transmitter system utilizes dense wavelength division multiplexing (DWDM).

7. The method of claim 1 wherein the photo device is a photodiode.

8. The method of claim 1 wherein the different parts of the allocated downstream radio frequency spectrum correspond to different cable television services.

9. A system for providing multiple services in a hybrid fiber coax (HFC) cable television (CATV) network, the cable television network including a headend that distributes signals over fiber to field nodes in the cable television network, the signals being distributed through the neighborhoods to subscribers from the field nodes, the distributed signals from the headend including a plurality of channels containing digital data for cable television services, the digital data being modulated onto radio frequency sub-carriers within an allocated downstream radio frequency spectrum, the system comprising:
a transmitter system including an array of lasers, the transmitter system utilizing wavelength division multiplexing (WDM) to combine different wavelengths from the laser array and launch them onto a single fiber;
a receiver system including a photo device having an output, the optical signals from the single fiber impinging on the photo device; and
a splitter for splitting the allocated downstream radio frequency spectrum into parts such that different parts of the spectrum are transmitted by different lasers of the array of lasers in the transmitter system, the photo device in the receiver system reproducing the combined radio frequency spectrum at the photo device output.

10. The system of claim 9 wherein the digital data is modulated onto the radio frequency sub-carriers within the allocated downstream radio frequency spectrum utilizing multilevel quadrature amplitude modulation (M-QAM).

11. The system of claim 9 wherein the digital data include digital data for voice service.

12. The system of claim 9 wherein the digital data include digital data for video service.

13. The system of claim 9 wherein the digital data include digital data for Internet access service.

14. The system of claim 9 wherein the transmitter system utilizes dense wavelength division multiplexing (DWDM).

15. The system of claim 9 wherein the photo device is a photodiode.

16. The system of claim 9 wherein the different parts of the allocated downstream radio frequency spectrum correspond to different cable television services.
